(19) United States
(12) Patent Application Publication
(10) Pub. No.: US 2004/0198854 A1
(43) Pub. Date: Oct. 7, 2004

(54) Expandable resin composition and propylene-based resin foam

(75) Inventors: Hiroaki Takahata, Ichihara-shi (JP); Satoshi Hanada, Ichihara-shi (JP); Ryuma Kuroda, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/791,387

(22) Filed: Mar. 3, 2004

(30) Foreign Application Priority Data
Mar. 6, 2003 (JP) 2003-059605

(51) Int. Cl. C08K 3/00; C08J 9/00

(52) U.S. Cl. 521/97

(57) ABSTRACT

Disclosed is an expandable resin composition comprising an olefin-based copolymer (a) and a thermally decomposable foaming agent (b) kneaded therein, wherein the olefin-based copolymer is composed of 5 to 50% by weight of monomer units derived from propylene and 95 to 50% by weight of monomer units derived from 1-butene.

### BACKGROUND OF THE INVENTION

1. Field of the Invention

The present invention relates to expandable resin compositions suitable for use in the production of propylene-based resin foams and to propylene-based resin foams produced by use of the expandable resin compositions.

2. Description of the Related Art

The demand for propylene-based resin foams as, for example, packaging materials and automotive materials has been increased because they are superior, for example, in heat insulation property, lightweight property, heat resistance and recyclability. Especially, foams having both a light weight and a high strength are sought. For the purpose of weight reduction, foams are required to have a high expansion ratio. However, the strength is reduced with increase of the expansion ratio. In order to form a foam with a higher expansion ratio at a certain expansion ratio, the foam is required to have fine cells.

As a method for producing propylene-based resin foams, a method is commonly employed in which a propylene-based resin foam is produced by melt-kneading a foaming agent and a propylene-based resin together. Foamable compounds which are decomposed by heat, namely thermally decomposable foaming agents, such as citric acid, carbonates and hydrogencarbonates, are widely employed. When a thermally decomposable foaming agent is used as a foaming agent, in view of ease of handling and improvement indispersibility, usually employed is an expandable resin composition obtained by kneading a thermoplastic resin and a thermally decomposable foaming agent. As one example of such expandable resin compositions, an expandable resin composition comprising a foaming agent and an ethylene-1-butene copolymer (see, for example, Japanese Patent Laid-Open No. 7-62131).

However, because the propylene-based resin foams produced by use of such propylene-based resin compositions have coarse cells, propylene-based resin foams having much smaller cells have been demanded.

### SUMMARY OF THE INVENTION

In light of such situations, the present inventors studied to develop propylene-based resin foams containing fine cells. As a result, they found that this problem can be solved through improvement of expandable resin compositions obtained in the course of the production of foams. Thus, the inventors have established the present invention.

The present invention provide an expandable resin composition comprising an olefin-based copolymer (a) and a thermally decomposable foaming agent (b) kneaded therein, wherein the olefin-based copolymer is composed of 5 to 50% by weight of monomer units derived from propylene and 95 to 50% by weight of monomer units derived from 1-butene. The invention also provides a propylene-based resin foam produced by use of the expandable resin composition.

### BRIEF DESCRIPTION OF THE DRAWINGS

FIG. 1 illustrates one example of the apparatus for producing the propylene-based resin foam of the present invention.

FIG. 2 illustrates one example of the shape of a cross section of the circular die for use in the production of the propylene-based resin foam of the present invention.

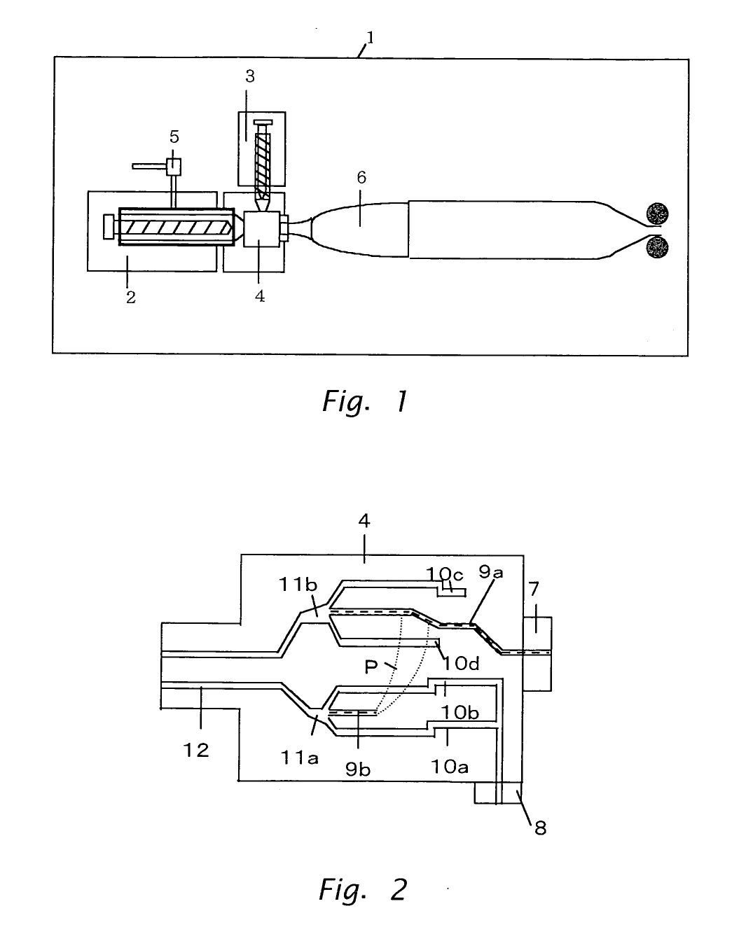

In the drawings, each of the reference letters and numerals has a meaning given below:

1: apparatus for producing propylene-based resin foams;

2: 50mmφ twin screw extruder;

3: 32mmφ single screw extruder;

4: circular die;

5. pump for supplying carbon dioxide gas;

6. mandrel;

7. 50mmφ head of twin screw extruder;

8. 32mmφ head of single screw extruder; and 9a, 9b, 10a, 10b, 10c, 10d: passageway.

### DESCRIPTION OF PREFERRED EMBODIMENTS

The olefin-based copolymer (a), which is one of the constituents of the expandable resin composition of the present invention, is composed of 5 to 50% by weight of monomer units derived from propylene and 95 to 50% by weight of monomer units derived from 1-butene. Use of the olefin-based copolymer having the composition mentioned above allows propylene-based resin foams produced using the expandable resin composition of the present invention as a foaming agent to be propylene-based resin foams having fine cells. If the olefin-based copolymer contains the monomer units derived from propylene in an amount less than 5% by weight, a propylene-based resin foam having coarse cells will be obtained because of a poor compatibility between the propylene-based resin constituting the foam and the olefin-based copolymer constituting the expandable resin composition. If the content of the monomer units derived from propylene is more than 50% by weight, the olefin-based copolymer will have a high melting point and, accordingly, a thermally decomposable foaming agent will decompose in the course of production of an expandable resin composition by kneading the thermally decomposable foaming agent with the olefin-based copolymer. It, therefore, will become impossible for the expandable resin composition to generate gas of an amount necessary for the production of foams.

The thermally decomposable foaming agent (b) used in the present invention is a foamable compound which generates gas when being decomposed by being heated. Thermally decomposable foaming agents commonly employed for the formation of foams can be used. Examples thereof include citric acid, carbonates and hydrogencarbonates.

The thermally decomposable foaming agent (b) may be composed of only one kind of foamable compound. It, however, is preferable that the thermally decomposable foaming agent (b) be composed of the combination of a thermally decomposable foaming agent (b-1) having a decomposition temperature of 130 to 190° C. and a thermally decomposable foaming agent (b-2) having a decomposition temperature higher than 190° C. but not higher than 230° C. The use of thermally decomposable foaming agents differing in decomposition temperature results in an expandable resin composition which can yield foams having finer cells. When the thermally decomposable foaming agents (b-1) and (b-2) are used in combination, it is more preferable to select (b-1) and (b-2) so that the difference in decomposition temperature between the thermally decomposable foaming agents (b-1) and (b-2) is 10° C. or more. It is especially preferable that the difference in decomposition temperature be 30° C. or more.

Each of the thermally decomposable foaming agents (b-1) and (b-2) may be composed either of a single component or of two or more components.

Regarding the proportion between (b-1) and (b-2), they may be combined appropriately so as to generate gas of a necessary quantity at a desired temperature. However, the (b-1)/(b-2) weight ratio preferably ranges from 10/90 to 90/10.

Especially, it is preferable that the thermally decomposable foaming agent (b-1) be at least one compound selected from group (A) defined below and the thermally decomposable foaming agent (b-2) be citric acid. Use of expandable resin compositions containing such decomposable foaming agents makes it possible to produce foams having extremely fine cells.

(A) Alkali metal hydrogencarbonates, alkaline earth metal hydrogencarbonates, ammonium hydrogencarbonate, alkali metal carbonates, alkaline earth metal hydrogencarbonates and ammonium carbonate.

Of the compounds in group (A), sodium carbonate or sodium hydrogencarbonate is preferably employed because a large quantity of gas is formed per unit weight.

The amounts of the olefin-based copolymer and the thermally decomposable foaming agent contained in the expandable resin composition of the present invention are not particularly restricted. However, if the amount of the thermally decomposable foaming agent is too large, the expandable resin composition will become fragile and difficult to be handled or the compatibility between the propylene-based resin constituting the foam and the expandable resin composition will become poor, so that the foam will tend to contain coarser cells. On the other hand, if the amount of the foaming agent is too small, an insufficient amount of gas will tend to be formed. Therefore, the thermally decomposable foaming agent is usually incorporated in an amount of 10 to 800 parts by weight based to 100 parts by weight of the olefin-based copolymer.

The expandable resin composition of the present invention preferably contains any of a neutralizer (c) and a moisture absorbent (d) appropriately depending on the kind of the thermally decomposable foaming agent (b) contained. It is more preferable to incorporate both the neutralizer (c) and the moisture absorbent (d). The incorporation of the neutralizer (c), the moisture absorbent (d) or both makes it possible to control the decomposition temperature or the decomposition speed of the thermally decomposable foaming agent.

As the neutralizer, alkali metal salts or alkaline earth metal salts of organic acids are preferably employed. Of the organic salts, a compound selected from group B defined below is more preferably employed.

Group B: oxalic acid, formic acid, acetic acid, propionic acid, caprylic acid and stearic acid.

Especially, stearates such as sodium stearate, potassium stearate and zinc stearate are particularly preferably employed.

In the case of incorporating the neutralizer, its incorporations amount is usually from 0.1 to 20 parts by weight based on 100 parts by weight of the olefin-based copolymer.

As the moisture absorbent, salts such as calcium chloride and potassium chloride and metal oxides such as calcium oxide and potassium oxide are preferably employed. Of the salts and oxides, calcium oxide is preferably employed.

In the case of incorporating the moisture absorbent, its incorporation amount is usually from 0.1 to 20 parts by weight based on 100 parts by weight of the olefin-based copolymer.

Moreover, the expandable resin composition of the present invention preferably contains an inorganic filler (e) in addition to the olefin-based copolymer and the thermally decomposable foaming agent. Such an expandable resin composition can yield a propylene-based resin foam having fine cells with stability under a wide range of processing conditions because the inorganic filler functions as a cell regulator to form nuclei of bubbles. Incorporation of too much inorganic filler tends to inhibit the thermally decomposable foaming agent from dispersing to form cells unevenly. Therefore, the amount of the inorganic filler incorporated is preferably up to 200 parts by weight based on 100 parts by weight of the thermally decomposable foaming agent. Examples of the inorganic filler to be employed include talc, clay, silica and titanium oxide. Especially, use of talc is preferable because foams having particularly fine cells can be obtained. As the talc for use herein, those having an average particle diameter ranging from 1 to 10 μm are particularly preferably employed because they exhibit good dispersibility and easily yield foams having even cells while serving as cell regulators.

Although depending on conditions such as the kinds and incorporation amounts of the olefin-based copolymer and foaming agent to be used; any of the neutralizer (c), the moisture absorbent (d) and the inorganic filler (e) is preferably contained. Especially, it is more preferable that all of those ingredients are contained together from the viewpoint of reduction in size of cells in foams.

The expandable resin composition of the present invention may appropriately contain other additives so that the effect of the present invention is not affected. Examples of the additives include antioxidants, light stabilizers, ultraviolet absorbers, plasticizers, antistatic agents, colorants, release agents, fluidizing agents and lubricants.

The expandable resin composition of the present invention may contain thermoplastic resin other than the olefin-based copolymer composed of 5 to 50% by weight of monomer units derived from propylene and 95 to 50% by weight of monomer units derived from 1-butene. Examples of the other thermoplastic resin include ethylene-vinyl ester copolymer, ethylene-(meth)acrylic acid copolymer, ethylene-(meth)acrylate copolymer, polyester resin, polyamide resin, polystyrene resin, acryl resin, acrylonitrile resin, poly(vinyl alcohol) and ionomer resin. When the expandable resin composition contains such additional thermoplastic resin, the content thereof is within the bounds of not affecting the effect of the present invention, and is usually up to 10% by weight.

The expandable resin composition of the present invention can be produced without any particular limitations by any method in which an olefin-based copolymer and a thermally decomposable foaming agent is kneaded together. For example, usable is a method comprising heating an olefin-based copolymer to a temperature equal to or higher than the melting point of the olefin-based copolymer to melt-plasticize it, then adding a thermally decomposable foaming agent and, if necessary, a neutralizer, a moisture absorbent, an inorganic filler and other additives, and subsequently kneading the mixture.

It is preferable that the thermally decomposable foaming agent is dispersed uniformly in the expandable resin composition. In the production of the expandable resin composition, therefore, it is preferable to knead the olefin-based copolymer and the thermally decomposable foaming agent so much that the thermally decomposable foaming agent does not decompose, at a temperature lower than the decomposition temperature of the thermally decomposable foaming agent. It is more preferable to conduct the kneading at a temperature ranging from (the temperature higher than the melting point of the olefin-based copolymer by 5° C.) to (the temperature lower than the decomposition temperature of the thermally decomposable foaming agent by 10° C.).

In the method for producing the expandable resin composition of the present invention, known kneading device may be employed. Examples thereof include ribbon blenders, high-speed mixers, kneaders, mixing rolls, single screw extruders, twin screw extruders and intensive mixers.

The propylene-based resin foam of the present invention can be produced by melt-kneading a propylene-based resin and the expandable resin composition of the present invention by a commonly known method using the expandable resin composition of the present invention as a foaming agent, and then foaming the melt-kneaded material. There is no particular limitation on the method used for the production of the foam of the present invention.

When extrusion forming using an extruder is employed, the propylene-based resin foam can be obtained by melt-kneading a propylene-based resin and the expandable resin composition of the present invention in the extruder, then extruding the kneaded material into the atmosphere through a die to allow the material to foam. In this case, a propylene-based resin foam can be produced also [1] by further adding a thermally decomposable foaming agent during the melt-kneading and then extruding the kneaded material into the atmosphere through the die to allow the material to foam, or [2] by melt-kneading a propylene-based resin and the expandable resin composition of the present invention, further adding (or pouring) a physical foaming agent when the thermally decomposable foaming agent in the expandable resin composition has decomposed and continuing to knead, and then extruding the kneaded material into the atmosphere through the die to allow the material to foam.

In the cases of [1] and [2] above, the thermally decomposable foaming agent in the expandable resin composition is decomposed first to form nuclei of bubbles. Then, the gas which is formed, in the case of [1], by decomposition of the additional thermally decomposable foaming agent or the physical foaming agent in the case of [2] will expand around those bubble nuclei to form cells.

The expandable resin composition of the present invention is so compatible with a propylene-based resin that it is dispersed uniformly in the propylene-based resin. As a result, cells grown around the dispersed composition also become uniform. Therefore, the resulting propylene-based resin foam will contain fine cells.

The thermally decomposable foaming agent which is further added in the method of [1] above may be a compound which is used as the thermally decomposable foaming agent (b) incorporated in the expandable resin composition of the present invention. However, a thermally decomposable foaming compound having a decomposition temperature higher than that of the thermally decomposable foaming agent contained in the expandable resin composition is usually employed.

Examples of such a high-temperature decomposition type thermally decomposable foaming compound include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzensulphonyl hydrazide); and thermally decomposable inorganic foaming agents (e.g., sodium hydrogencarbonate, ammonium carbonate and ammonium hydrogencarbonate).

In the cases of further adding a thermally decomposable foaming compound, it is preferable to use pellets obtained by pelletizing the thermally decomposable foaming compound and a resin together in view of ease to handle. In this case, any olefin-based resin is available with no particular limitations. However, ethylene-based resins or propylene-based resins are preferable.

As the physical foaming agent used in the method of [2] above, physical foaming agents used in the production of common foams, such as propane, butane, water and carbon dioxide gas, can be employed. Of these, substances inert at high temperatures or to fire, such as water and carbon dioxide gas, are preferably employed in view of the safety in the production of foams. Especially in the production of propylene-based resin foams, use of carbon dioxide gas is preferable because the gas is less liable to escape and, therefore, foams containing fine cells are obtained.

In the case of producing propylene-based resin foams using only a physical foaming agent, it is generally difficult to produce foams containing fine cells. However, as in the method of [2] above, a propylene-based resin foam obtained by melt-kneading a propylene-based resin, the expandable resin composition of the present invention and a physical foaming agent together and then allowing the mixture to foam will contain cells finer than that contained in a propylene-based resin foam obtained without adding the expandable resin composition. Especially, when carbon dioxide gas is used as the physical foaming agent, the effect of reducing the size of fine cells by use of the expandable resin composition of the present invention becomes noticeable and propylene-based resin foams containing extremely fine cells can be obtained.

Examples of the propylene-based resins to be used in the propylene-resin foam of the present invention include propylene homopolymers and propylene-based copolymer containing at least 50 mol % of propylene units. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1, 1-hexene and 1-octene. The content of the monomer units except propylene in the propylene-based copolymer is preferably up to 15 mol % for ethylene and up to 30 mol % for α-olefins having 4 to 10 carbon atoms.

Use of a long-chain branched propylene-based resin (a-1) or a propylene-based resin having a weight average molecular weight of 1×10⁵ or more (a-2) as a propylene-based resin in an amount of at least 50% by weight of the whole propylene-based resin makes it possible to obtain a propylene-based resin foam containing finer cells.

By the long-chain branched propylene-based resin used herein is meant a propylene-based resin whose branching index [A] satisfies 0.20≦[A]≦0.98. The propylene-based resin used herein include propylene homopolymers and propylene copolymers composed of propylene with at least one monomer selected from the group consisting of ethylene and α-olefins having 4 to 10 carbon atoms. The copolymers may be block copolymers, random copolymers and graft copolymers.

One example of the long-chain branched propylene-based resins having a branching index [A] satisfying 0.20≦[A]≦0.98 is Propylene PF-814 manufactured by Montell Co.

The branching index quantifies the degree of long chain branching in a polymer and is defined by the following formula.

Branching Index [A]=[η]_{Br}/[η]_{Lin}

In the formula, [η]_{Br} is the intrinsic viscosity of the long-chain branched propylene-based resin. [η]_{Lin} is the intrinsic viscosity of a linear propylene-based resin composed of the same monomer units as the long-chain branched propylene-based resin and having the same weight average molecular weight as that of the long-chain branched propylene-based resin.

The intrinsic viscosity, which is also called a limiting viscosity number, is a measure of the capacity of a polymer to enhance the viscosity of its solution. The intrinsic viscosity depends especially on the molecular weight and on the degree of branching of the polymer molecule. Therefore, the ratio of the intrinsic viscosity of the long-chain branched polymer to the intrinsic viscosity of a linear polymer having the same weight average molecular weight as that of the long-chain branched polymer can be used as a measure of the degree of branching of the long-chain branched polymer. The intrinsic viscosity of a propylene-based resin can be determined by a conventionally known method such as that described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin can be determined by various methods commonly used. Particularly preferably employed is the method reported by M. L. McConnel et al. in American Laboratory, May, 63-75 (1978), namely, the low-angle laser light-scattering intensity measuring method.

One example of the method for polymerizing a propylene-based resin having a weight average molecular weight of 1×10⁵ or more is the method described in Japanese Patent Laid-Open No. 11-228629.

Of those propylene-based resins (a-1) and (a-2), a preferred one is a propylene-based resin such that, when the propylene-based resin is measured for its uniaxial elongation viscosity by means of a uniaxial elongation viscometer (for example, a uniaxial elongation viscometer manufactured by Rheometrics, Inc.) at a temperature near (the temperature higher than the melting point by 30° C.) at an elongation strain rate of 1 sec⁻¹, the ratio of η₅ to η_{0.1} (η₅/η_{0.1}) satisfies η₅/η_{0.1}≦10 wherein the uniaxial melt elongation viscosity measured at the time when 0.1 second has passed since strain was begun to be applied is indicated by η_{0.1} and the uniaxial melt elongation viscosity measured at the time when 5 seconds has passed since strain was begun to be applied is indicated by η₅. A propylene-based resin satisfying η₅/η_{0.1}≦5 is more preferable. Using propylene-based resins satisfying such conditions, foams containing very fine cells can be produced.

With regard to the incorporation ratio of a propylene-based resin and the expandable resin composition of the present used in the production of the propylene-based resin foam of the present invention, the optimum range thereof is not particularly restricted and may be selected depending on various conditions such as the content of the thermally decomposable foaming agent in the expandable resin composition, the expansion ratio of the desired propylene-based resin foam, the physical properties of the propylene-based resin to be used and the melt-kneading temperature. However, the expandable resin composition of the present invention is normally used in an amount ranging from 0.5 to 20 parts by weight per 100 parts by weight of the propylene-based resin.

Like the above, the quantities of the thermally decomposable foaming compound and physical foaming agent further added in the course of the melt-kneading of the propylene-based resin and the expandable resin composition of the present invention may be appropriately determined depending on various conditions and are not particularly restricted. However, in the case where a thermally decomposable foaming compound is used together, the expandable resin composition of the present invention and the thermally decomposable foaming compound are used normally in amounts of 0.5 to 5 parts by weight and 1 to 10 parts by weight, respectively, based on 100 parts by weight of the propylene-based resin. When the physical foaming agent is used together, the expandable resin composition of the present invention and the physical foaming agent are used normally in amounts of 0.5 to 20 parts by weight and 0.1 to 5 parts by weight, respectively, based on 100 parts by weight of the propylene-based resin.

In the present invention, how fine the cells in a propylene-based resin foam are is evaluated based on the cell wall density in the thickness direction of the foam. The cell wall density of a foam is defined to be a value determined by the method described below. Across section of the foam is first enlarged by a scanning electron microscope (SEM) to a magnification at which every cell can be recognized clearly. Then, on the enlarged image, one straight line is drawn along the thickness direction of the foam and the number of the cell walls crossing with the straight line, namely, the number of resin walls defining cells, is counted. Based on the result, the number of the number of the cell walls present in the foam layer per mm along the thickness direction of the same layer. In this manner, the number of cell walls present in the foam layer per mm along the thickness direction of the same layer was determined at five or more points, each point being 1 mm or more away from the other. The average of the numbers of cell walls is defined as the cell wall density in the thickness direction of the propylene-based resin foam of the present invention. The greater the cell wall density, the finer the cells.

The propylene-based resin foam of the present invention is superior in mechanical strength and heat insulation property because it contains fine cells. Such a propylene-based resin foam hardly causes breakage of cells even in secondary forming such as vacuum molding. Therefore, a molded article resulting from the secondary forming is also superior in mechanical strength and heat insulation property.

The propylene-based resin foam of the present invention may have other thermoplastic resin layers. When the propylene-based resin foam of the present invention has other thermoplastic resin layers, the thickness of the foam layer is used as the thickness of the foam used in the calculation of the cell wall density.

The propylene-based resin foam of the present invention can be employed in various applications after, if necessary, being subjected to processing such as shaping. Concretely, it can be employed suitably as food containers such as trays, bowls, cups and boxes; heat insulators, cushioning materials for sports goods or wrapping materials; automotive parts such as vehicle ceiling materials; sealing materials; and building materials. Especially, it can be suitably employed in the form of a food container such as microwavable containers by use of the heat insulation property of the propylene-based resin.

The expandable resin composition of the present invention exhibits a superior compatibility with propylene-based resins because it is constituted of a thermally decomposable foaming agent and a specific olefin-based copolymer. Therefore, the propylene-based resin foam produced using the expandable resin composition as a foaming agent will contain fine cells.

The present invention will be described with reference to examples. The invention, however, is not limited to the examples.

### EXAMPLE 1

A 2-kind 3-layer propylene-based resin foam composed of a propylene-based resin foam layer having on each side thereof a non-foam layer was prepared by the method described below.

(Method for Preparing an Expandable Resin Composition)

An expandable resin composition was prepared by the method shown below.

Into a Banbury type kneading device, 45 parts by weight of an olefin-based copolymer (a) (TAFMER BL2481 manufactured by Mitsui Chemicals, Inc., 1-butene/propylene weight ratio=80/20, melting point=75° C.) was charged and melted at 115° C. through kneading. While the kneading was carried out, 20 parts by weight of a thermally decomposable foaming agent (b)having a sodium hydrogencarbonate (decomposition temperature 153° C.)/citric acid (decomposition temperature 215° C.) weight ratio=10/10 and 30 parts by weight of talc (e) (Talc MICRON WHITE #5000S, manufactured by Hayashi Kasei Co., Ltd., average particle diameter=2.8 μm) were charged sequentially and the kneading was continued for 10 minutes. The resulting material was charged into a 40 mmφ single screw extruder and was extruded into strands, which were cut with a pelletizer to form a pellet-shaped expandable resin composition.

(Pelletization of Propylene-Based Copolymer)

To 100 parts by weight of a propylene-based copolymer powder prepared by the method disclosed in Japanese Patent Laid-Open No. 11-228629, 0.1 part by weight of calcium stearate, 0.05 part by weight of a phenol-type anitoxidant (trade name: Irganox 1010, manufactured by Ciba Specialty Chemicals), 0.2 part by weight of a phenol-type antioxidant (trade name: Sumilizer BHT, manufactured by Sumitomo Chemical Co., Ltd.) were added and mixed. The mixture was kneaded at 230° C. to yield pellets [i] having a melt flow rate of 4.5 g/10 minutes (at 230° C. under a load of 2.16 kgf).

The physical properties of the resulting propylene-based copolymer are as follows.

Physical properties of propylene-based copolymer Limiting viscosity number of component (A) (the component having a higher molecular weight of the two components contained in the propylene-based copolymer obtained by the method disclosed in Japanese Patent Laid-Open No. 11-228629) ([η]A)=9.5 dl/g; ethylene content in component (A) (C2 in A)=2.9%; limiting viscosity number of component (B) (the component having a lower molecular weight of the two components contained in the propylene-based copolymer obtained by the method disclosed in Japanese Patent Laid-Open No. 11-228629) ([η]B)=11 dl/g; ethylene content in component (B) (C2 in B)=2.7%. η₅=300000 Pa·s, η_{0.1=2900} Pa·s, measured at 180° C. using a uniaxial elongation viscometer manufactured by Rheometrics, Inc.

(Material for Forming a Foam Layer)

The propylene-based polymer pellets [i] obtained by the method described above, [ii] polypropylene 1 (Polypropylene R101 manufactured by Sumitomo Chemical Co., Ltd., MFR=20 g/10 min (at 230° C., under a load of 2.16 kgf)), and [iii] polypropylene 2 (Polypropylene U101E9, MFR=120 g/10 min (at 230° C., under a load of 2.16 kgf)) were dry-blended in a [i]/[ii]/[iii] weight ratio of 70/21/9 to form a material for forming a foam layer.

(Material for Forming Non-foam Layer)

[iv] Polypropylene 3 (Polypropylene FS2011DG2 manufactured by Sumitomo Chemical Co., Ltd., MFR=2.5 g/10 minutes (at 230° C. under a load of 2.16 kgf)), [v] polypropylene 4 (Polypropylene W151 manufactured by Sumitomo Chemical Co., Ltd., MFR=8 g/10 minutes (at 230° C. under a load of 2.16 kgf)), [vi] polypropylene 5 (Polypropylene PF814 manufactured by Montell, MFR=3 g/10 minutes (at 230° C. under a load of 2.16 kgf)), [vii] a talc masterbatch (polypropylene-base talc master batch MF110 manufactured by Sumitomo Chemical Co., Ltd., talc content=70% by weight), and [viii] titanium oxide masterbatch (polyethylene-base titanium oxide masterbatch SPEM7A1155 manufactured by Sumika Color Co., Ltd., titanium oxide content=60% by weight) were dry-blended in a [iv]/[v]/[vi]/[vii]/[viii] weight ratio of 21/30/20/29/5 to form a material for forming non-foam layers.

(Method for Producing a Propylene-Based Resin Foam)

Using the material for forming a foam layer, the expandable resin composition and the material for forming non-foam layers, a propylene-based resin foam was produced by extrusion forming using an apparatus (1) equipped with a 50 mmφ twin screw extruder (2) for extruding the foam layer, a 32 mmφ single screw extruder (3) for extruding the non-foam layers and a 90 mmφ circular die (4).

A raw material resulting from the blend of 100 parts by weight of the material for forming a foam layer and 2 parts by weight of the expandable resin composition was fed to the 50 mmφ twin screw extruder (2) through a hopper. It was then kneaded in a cylinder heated at 180° C.

When the material for forming a foam layer and the expandable resin composition had been melt-kneaded fully to be compatibilized together and the thermally decomposable foaming agent in the expandable resin composition had been thermally decomposed to foam in the 50 mmφ twin screw extruder (2), 1 part by weight of carbon dioxide gas as a physical foaming agent was poured from a pump (5) connected to a liquefied carbon dioxide cylinder. After the pouring of carbon dioxide gas, the kneaded material was impregnated with the carbon dioxide gas through a further kneading and then fed to the circular die (4).

The material for forming a non-foam layer was melt-kneaded in the 32 mmφ single screw extruder (3) and then fed to the circular die (4).

In the circular die (4), the material for forming a foam layer introduced into the die through a head (7) of the 50 mmφ twin screw extruder was transmitted toward the outlet of the die through a passageway (9a). On the midway in the passageway (9a), the material was divided through a path P and transmitted also to a passageway (9b).

The material for forming a non-foam layer was introduced into the die through a head (8) of the 32 mmφ single screw extruder (3) and then divided into passageways (10a) and (10b). After the division, the material was transmitted toward the outlet of the die while being supplied so as to be laminated on both sides of the passageway (9b). At a point (11a), the lamination was achieved. The material for forming non-foam layers, which was supplied into the passageways (10a) and (10b), was divided and transmitted into passageways (10c) and (10d) through branching paths (not shown) similar to the path P. Then the material was transmitted toward the outlet of the die while being supplied so as to be laminated on both sides of the passageway (9a). At a point (11b), the lamination was achieved. The molten resin fabricated into a tubular 2-kind 3-layer structure at (11a) and (11b) was extruded through the outlet (12) of the circular die (4). The release of the tubular resin to atmospheric pressure allowed the carbon dioxide gas contained in the material for forming a foam layer to expand to form bubbles. Thus, the layer of the material for forming a foam layer turned into a foam layer. As a result, a 2-kind 3-layer propylene-based resin foam having a thickness of 1.2 mm was obtained.

The 2-kind 3-layer foam extruded through the die was stretched and cooled while being drawn over a mandrel (6) having a maximum diameter of 210 mm to form a tube. The resulting tubular foam was slit longitudinally into one 660 mm wide flat sheet, which was then drawn through drawing rolls and wound up around a wind-up roll.

### EXAMPLE 2

A propylene-based resin foam having a thickness of 1.2 mm was prepared in the same manner as Example 1 except further adding 2 parts by weight of sodium stearate (c) and 0.6 part by weight of calcium oxide (d) during the addition of 20 parts by weight of the thermally decomposable foaming agent (b) and 30 parts by weight of talc (e).

### COMPARATIVE EXAMPLE 1

A propylene-based resin foam having a thickness of 1.2 mm was prepared in the same manner as Example 1 except using a copolymer composed of 1-butene and ethylene with a 1-butene/ethylene weight ratio of 83/17 as the olefin-based copolymer constituting the expandable resin composition.

(Measurement of Expansion Ratio)

A propylene-based resin foam sampled in a size 20 mm×20 mm was measured for the specific gravity by means of an immersion-type densimeter (Automatic Densimeter, D-H100, manufactured by Toyo Seiki Seisaku-Sho Co., Ltd.) The expansion ratio was calculated based on the densities of the materials constituting the foam.

(Measurement of Cell Wall Density in the Thickness Direction of a Foam Layer)

A cross section of the foam layer in a propylene-based resin foam was photographed by a scanning electron microscope. The magnification was adjusted so that cells present in the field of vision of the electron microscope could be recognized clearly. In the enlarged image obtained, one straight line was drawn along the thickness direction of the foam layer and the number of cell walls intersecting the straight line was counted. Based on the result, the number of the cell walls present in the foam layer per mm along the thickness direction of the same layer. In this manner, the number of cell walls present in the foam layer per mm along the thickness direction of the same layer was determined at five points, each point being 1 mm or more away from the other. The average of the numbers determined was used as the cell wall density in the thickness direction of the foam layer. The greater the cell wall density in the thickness direction of the foam layer, the finer the cells in the propylene-based resin foam.

The propylene-based resin foams obtained in Examples 1-2 and Comparative Example 1 were evaluated by the methods described above. The results are shown in Table 1. In comparison to the propylene-based resin foam obtained in Comparative Example 1, the propylene-based resin foams obtained in Examples 1 and 2 are those having greater cell wall densities, in other words, containing finer cells.

TABLE 1

| | | | | Comparative |
|---|---|---|---|---|
| | Item | Example 1 | Example 2 | Example 1 |
| Foam | Thickness (mm) | 1.2 | 1.2 | 1.2 |
| | Expansion ratio | 3.0 | 3.0 | 3.0 |
| | (times) | | | |
| | Cell wall density | 17 | 23 | 13 |
| | (walls/mm) | | | |

1. An expandable resin composition comprising an olefin-based copolymer (a) and a thermally decomposable foaming agent (b) kneaded therein, wherein the olefin-based copolymer is composed of 5 to 50% by weight of monomer units derived from propylene and 95 to 50% by weight of monomer units derived from 1-butene.

2. The expandable resin composition according to claim 1, wherein the thermally decomposable foaming agent (b) comprises a thermally decomposable foaming agent (b-1) having a decomposition temperature of 130 to 190° C. and a thermally decomposable foaming agent (b-2) having a decomposition temperature higher than 190° C. but not higher than 230° C.

3. The expandable resin composition according to claim 1 or 2, wherein the composition contains any of a neutralizer (c), a moisture absorbent (d) and an inorganic filler (e).

4. A propylene-based resin foam obtained by melt-kneading the expandable resin composition according to claim 1 or 2 and a propylene-based resin and foaming the composition.

5. The propylene-based resin foam according to claim 4, wherein a physical foaming agent is further employed during the melt-kneading.

6. The propylene-based resin foam according to claim 5, wherein the physical foaming agent is carbon dioxide gas.

7. A propylene-based resin foam obtained by melt-kneading the expandable resin composition according to claim 3 and a propylene-based resin and foaming the composition.

8. The propylene-based resin foam according to claim 7, wherein a physical foaming agent is further employed during the melt-kneading.

9. The propylene-based resin foam according to claim 8, wherein the physical foaming agent is carbon dioxide gas.
